(19) United States
(12) Patent Application Publication
(10) Pub. No.: US 2020/0081893 A1
(43) Pub. Date: Mar. 12, 2020

(54) INTELLIGENT QUERY MANAGEMENT

(71) Applicant: Wells Fargo Bank, N.A., San Francisco, CA (US)

(72) Inventors: Shanmukeswara Rao Donkada, Hyderabad (IN); Rameshchandra Bhaskar Ketharaju, Hyderabad (IN); Ramanathan Ramanathan, Bellevue, WA (US); Nithin Rajan, Chennai (IN)

(21) Appl. No.: 16/047,320

(22) Filed: Jul. 27, 2018

(51) Int. Cl. G06F 16/2457; H04L 29/08; G06F 17/27; G06F 16/2458; G06F 16/25; G06F 16/248; G06F 16/23; G06F 16/22; G06F 16/2452; G06F 16/28

(52) U.S. Cl. CPC G06F 16/24575; H04L 67/20; G06F 17/2785; G06F 16/2465; G06F 16/285; G06F 16/248; G06F 16/2379; G06F 16/2282; G06F 16/24522; G06F 16/252

(57) ABSTRACT

The innovation disclosed and claimed herein, in one aspect thereof, comprises systems and methods of automatically routing internet forum users to forums and or other forum users capable of responding to their inquiries. The innovation calls for determining user context, and semantic context, and analyzing both to determine the appropriate forum. Additionally, the innovation may include evaluating other forum users from the chosen forum(s) to determine which particular forum user is best suited to respond the query.

### BACKGROUND

Making queries to internet search forums can be an imprecise undertaking. Typically, a requestor submits a query hoping that someone with adequate expertise will provide a useful response. Often responses are lacking. Sometimes, even choosing the correct forum on which to post a query is difficult, for example, due to ambiguous terminology used in the query. This can be especially troublesome when a query is made to solve work related problems. There is need for a system and method that automatically enable a user to connect with the appropriate team member or forum to solve such a query, taking into account user specific information in order to streamline the process.

### BRIEF SUMMARY OF THE DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of enabling context-based team member and customer connect. The innovation facilitates automatic identification of a team member or group for solving a problem posed by a user customer based on categorized team information and providing the solution in real time.

A system of the innovation can include a Team Member-Customer Connect Component which enters user context data in a data repository. Updated user context data may be pulled from third-party websites such as social media websites. A software application downloaded onto a user computing device may search for an appropriate forum or team member to resolve inquiries.

In aspects, the subject innovation provides substantial benefits in terms of time savings in internet forum queries. Another advantage resides in ability of the innovation to return responses from multiple forums simultaneously.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates an example component diagram of a system of the present innovation.

FIG. 2 illustrates a more detailed view of the Team Member Customer Connect Component.

FIG. 3 illustrates a more detailed view of the data repository.

FIG. 4 illustrates a more detailed view of the user interface.

FIG. 5 illustrates a method for routing a query to an appropriate user forum according to an aspect of the present innovation.

FIG. 6 illustrates a computer-readable medium or computer-readable device comprising processor-executable instructions configured to embody one or more of the provisions set forth herein, according to some embodiments.

FIG. 7 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

While certain ways of displaying information to users are shown and described with respect to certain figures as screenshots, those skilled in the relevant art will recognize that various other alternatives can be employed. The terms “screen,” “web page,” “screenshot,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

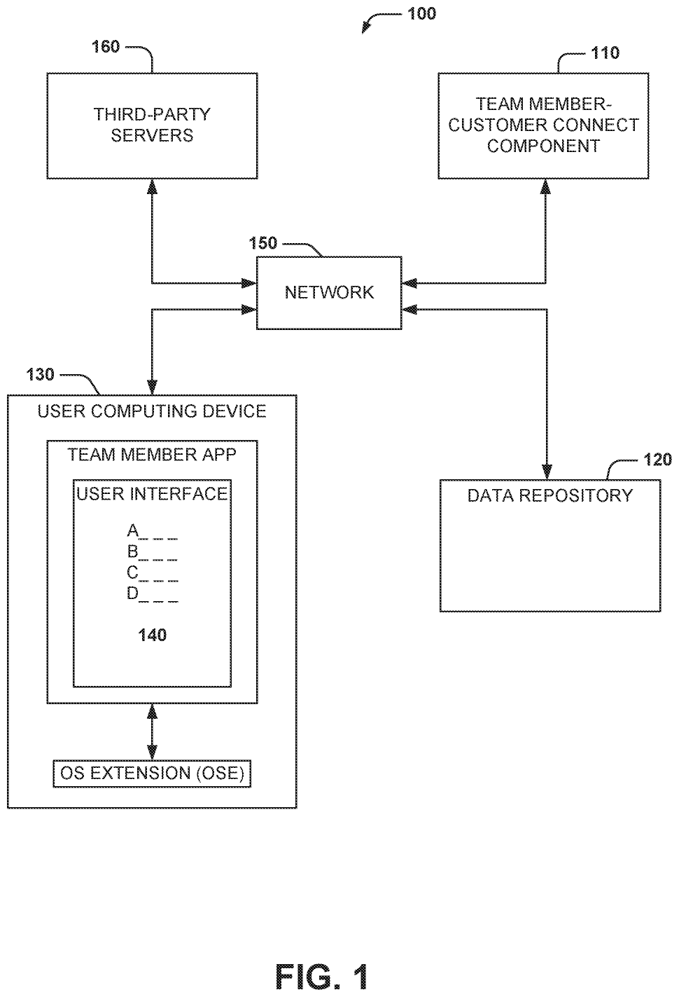

FIG. 1 illustrates a system 100 for context-based forum selection. The system 100 includes a Team Member Customer Connect Component (TMCCC) 110. The TMCCC 110 is coupled to a data repository 120 and a user device 130 which includes a user interface 140. The components are coupled via a network 150. In some embodiments, one or more third-party servers 160 are also coupled to the network 150. The TMCCC 110 retrieves user information from the data repository 120 and/or third party servers 160. The TMCCC 110 determines a user context based on an analysis of user data gathered from the data repository 120 and/or third party servers 160 such as social media servers.

The TMCCC 110 determines a semantic context using a semantic analysis. The semantic context can include a classification of the query that indicates what the query is asking. In some embodiments, the semantic analysis includes parsing the query to define each word that makes up the query. The semantic analysis can define what each word means in relation to the rest of the words to determine the semantic context.

The TMCCC 110 routes a query to one or more internet forums based on the user context and/or the semantic context. A forum is an online discussion site where people can hold conversations through posted messages. The conversations may be archived. Access to some or all content may be limited to registered users. Forums are a way for users to get answers to questions related to their specific user context. In routing a query to an internet forum, the TMCCC 110 accesses the data repository 120 to retrieve information such as forum names and the text of past posts and compares it to the user context and/or semantic context. The TMCCC 110 routes the query to the forum deemed the closest match.

In some embodiments, the TMCCC 110 may perform forum user routing. The TMCCC 110 can route the query to the proper forum user on the identified forum. The proper forum user is a forum user whose past queries and posts on the forum are sufficiently similar to the present query or demonstrate expertise in a field related to the query such that one can infer that the forum user may offer a helpful response. The TMCCC 110 accesses the data repository 120 to extract information (e.g. expertise, field of service, forum user response ratings and the like) and compare it with the context of the query to find the forum user most likely to return a helpful response to the query.

In some embodiments, the TMCCC 110 populates the data repository 120 with user attributes in and based on the attributes the TMCCC 110 gathers personal and public information of the user and aggregates the information in the data repository 120. The information is dynamically updated by the TMCCC 110 upon the addition of a new user device 130 or new user information.

In other embodiments, the TMCCC 110 registers users with the TMCCC 110 by downloading a team-member application from the TMCCC 110 to a user device 130. The TMCCC 110 receives attribute information such as name, contact information, and employment information directly from the user device 130. Such user information will be stored in the data repository 120.

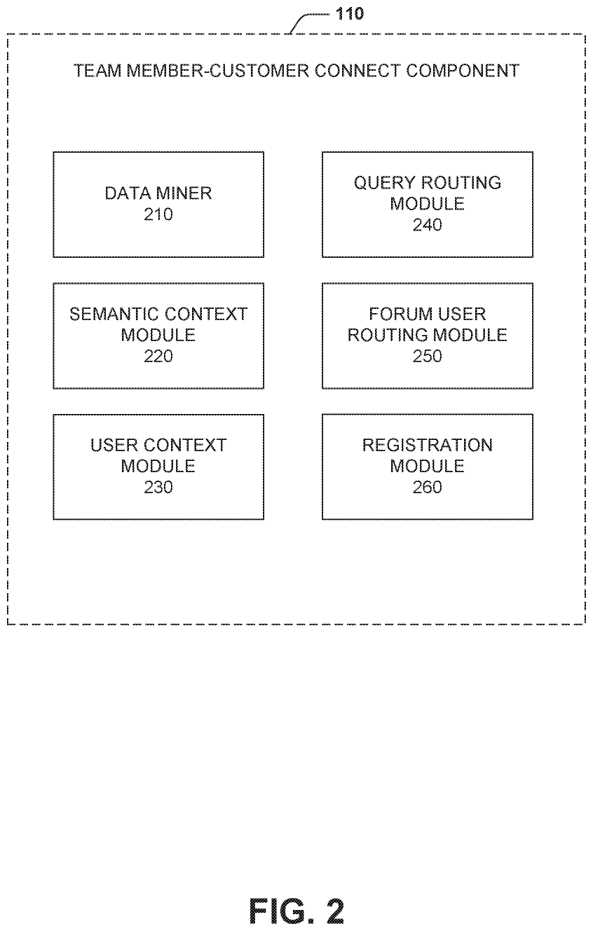

FIG. 2 illustrates an example component diagram of the TMCCC 110. The TMCCC 110 includes at least a data miner 210, a semantic context module 220, a user context module 230, a query routing module 240, a forum user routing module 250, and a registration module 260. The TMCCC 110 receives a query from the user interface 140.

The data miner 210 retrieves user information from the data repository 120 and/or third party servers 160. The semantic context module 220 determines a semantic context using a semantic analysis. The semantic context includes a classification of the query that indicates what the query is asking. In some embodiments, the semantic context includes an explicit and implicit intent of the query. The explicit intent is determined from the actual text of the query. For example, the plain text of the query can be “hypoallergenic large dogs home guardian?” The semantic context module 220 analyzes the keywords and the structure of the query and determine that a dog breed meeting certain characteristics is being sought. Implicit intent is determined by cross-referencing keywords of the query with related information from additional sources (e.g. third-party servers 160). Here, it can be implied that an animal is being sought as a pet or working animal given the type of work normally associated with dogs (e.g. from a third party website 150 such as wikipedia.org).

In some embodiments, the data miner 120 can construct an attribute table listing user attributes. Based on the attributes, the data miner 120 can construct an access table using personal and public information of the user. Both tables are located in the data repository 120. Both tables are dynamically updated by the data miner 120 upon the addition of a new user device 130 or new user information.

The user context module 230 determines a user context based on an analysis of user data gathered by the data miner 210. The user context module 230 cross references the semantic context with the information in the data repository 120 and/or publicly available information from the third-party servers 160 and/or other external data sources about the user who made the query. The user context is specific to the user submitting the query. The user context can provide a better understanding of why the user is submitting the query which in turn affects the routing of the query to the best forum. Continuing the above example, the user may have posted on a social media site that he prefers dogs with black coats and that he lives in a place with exceedingly cold and snowy winters.

The query routing module 240 routes a query to one or more forums based on the user context and/or semantic context. Based on the semantic context and the user context, the query routing module 240 accesses a forum database to retrieve information such as forum names and the text of past posts. The query routing module 240 compares the information from the forum database to the user context and semantic context. The query routing module 240 matches a forum in the forum database to the user context and semantic context. The query routing module 240 routes the query to the best matched forum. In some embodiments, the query routing module 240 determines a ranking of forums in the forum database. The query routing module 240 routes the query to a predetermined number of highest ranking forums.

Continuing the example above, the query routing module 240 cross-references the semantic context and user context with a third-party server 150 having a forum on dog breed traits (e.g. dogbreedforum.com). The query routing module 240 determines that a Black Russian Terrier forum meets the context of the query of the user as it is a large, hypo-allergenic dog native to a cold climate and originally developed for military service. Other hypo-allergenic dog breeds might be considered and then eliminated as they are too small or not suited for cold weather.

The query routing module 240 routes the query to the forum for Black Russian Terrier enthusiasts. The routing can be in a form of an automated post to the forum with the query. In some embodiments, the original text of the query is fully submitted to the forum as a post. In other embodiments, the query can be automatically modified according to forum posting rules found in the forum database. In other embodiments, the query can be converted in a plain language question if the query was provided by the user in incomplete sentences. In yet another embodiment, the query can be modified to include user context information to better facilitate soliciting a most accurate answer.

In some embodiments, the forum user routing module 250 determines a forum user routing. The forum user routing module 250 routes the query to a forum user of the forum where the query is routed by the query routing module 240. The forum user routing module 250 determines a forum user of the determined forum that has shown to be the best user to give the best answer to the query. The forum user routing module 250can determine a forum user whose past queries and posts on the forum are sufficiently related and/or similar to the present query as to reasonably believe the forum user may offer a helpful response.

The forum user routing module 250 accesses a profile database and the forum database to extract information about the forum user (e.g. expertise, field of service, forum user response ratings and/or the like). The forum user routing module 250 compares the information with the user context and semantic context of the query to find a forum user most likely to return a helpful response to the query. Continuing the above example, forum user John, a top Black Russian Terrier breeder and registered user who often posts queries and offers replies on the Black Russian Terrier forum, may be selected over another forum user, Susan, an owner of a Black Russian Terrier puppy and an infrequent forum user. In another example Bob, a computer engineer and registered user who often posts queries and offers replies on a Java forum (chosen over a C++ forum) may be selected over Casey, a hobby programmer who has posted sparingly on the Java forum, in the event of a user query regarding developing a program in Java.

The forum user routing module 250 generates a direct message to the determined best forum user. In some embodiments, the direct message includes the query. In other embodiments, the direct message includes a link to the query posted on the forum.

TMCCC 110 may also contain a registration module 260, whereby users may register with the TMCCC 110 by downloading a team-member application from the TMCCC 110 to a user device 130 and providing attribute information such as name, contact information, and employment information to the TMCCC 110. Such user information will be stored in databases housed in the data repository 120.

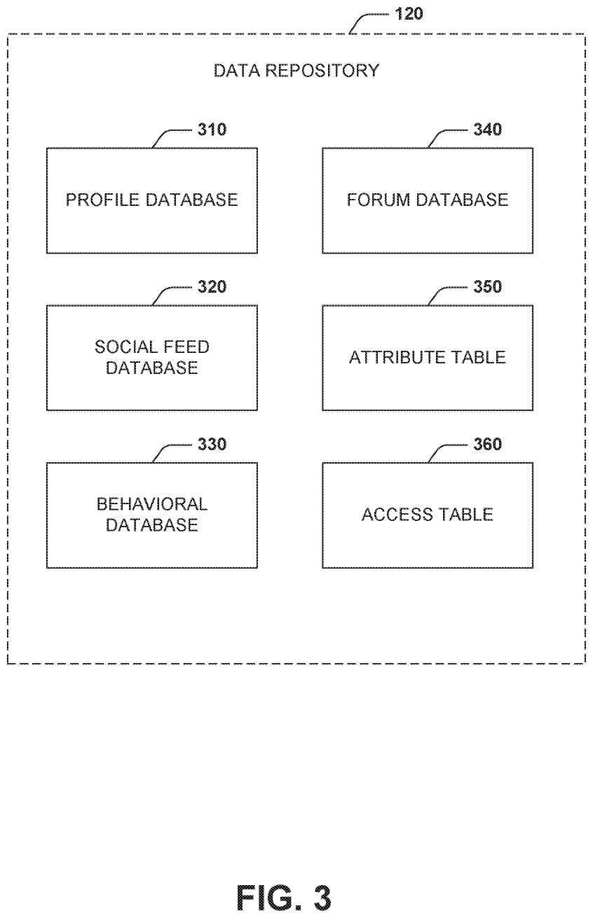

FIG. 3 illustrates an example component diagram of the data repository 120. The data respository 120 stores user context data. The user context data can be information used to characterize a situation or entity. The user context data is data that describes a user and or user behavior. In some embodiments, the user context data includes at least profile data, social feed data, behavioral data, attribute data, and/or access data. To store user context data, the data repository 120 includes a profile database 310, a social feed database 320, a behavioral database 330, an attribute table 340, an access table 350, and/or a forum database 360. It is appreciated that additional databases may also be included.

The profile database 310 stores identifying information for users such as name, address, credit card numbers, and/or the like. In some embodiments, such information is provided by the user during the registration process. In some embodiments, the profile information can be updated by the user manually or extracted by the data miner 210 at a later time during the normal course of data miner 210 operation. For example, the data miner 210 can access a user account and/or user device to determine the profile information.

The social feed database 320 stores at least information that may be gleaned about the user from social media websites. In some embodiments, the user may provide the TMCCC 110 with username and login information or otherwise provide access for social media websites with which he or she is associated. The data miner 210 may extract such information from public social media accounts belonging to the user or from other users.

The behavioral database 330 contains information such as bank account, credit card activity, user location history (e.g. from GPS logs associated with the cellular phone, automobile, or fitness tracker of the user), and/or the like. In some embodiments, the user may provide the TMCCC 110 with username and login or otherwise provide access information for associated tracking applications and the like. Additionally, the data miner 210 may extract such information from the public domain or in accordance with applicable user authorization agreements.

The forum database 340 contains information about forums accessible to the user. In some embodiments, the forum database contains forum information likely to be of interest to the user. The forum information includes personal information of forum users such as username, occupation, or other identifying information such as the titles, substance, and/or full text of past queries posted to such forums and answers to such queries. Login and username information to such forums may be supplied by users at registration in order to grant the TMCCC 110 access to private forum information. The data miner 210 searches out public forum information and the list of public forums from which information extracted is expanded. Third party servers 160 may provide data to the TMCCC 110 for updating at least the profile and social feed data in the data repository 120.

The TMCCC 110 builds an attribute table 350 and populates it with user attribute information for each user such as profile information, preferences or interests, volunteer limitation information with respect to time and degree/level of help offered to other users in answering queries (e.g. functional domain, technology domain, expertise, field of service, educational domain and so on) and/or the like. In some embodiments, the attribute table creates 350 a list of attributes in unorganized manner. Based on the attributes, the TMCCC 110 constructs the access table 360 using personal and public information of each user.

In some embodiments the attribute table 350 and the access table 360 may be stored in the TMCCC 110. In other embodiments, the attribute table 350 and access table 360 may be stored in a cloud-implemented access repository and dynamically updated on addition of new information or new users. The above described architecture can also support security and privacy requirements.

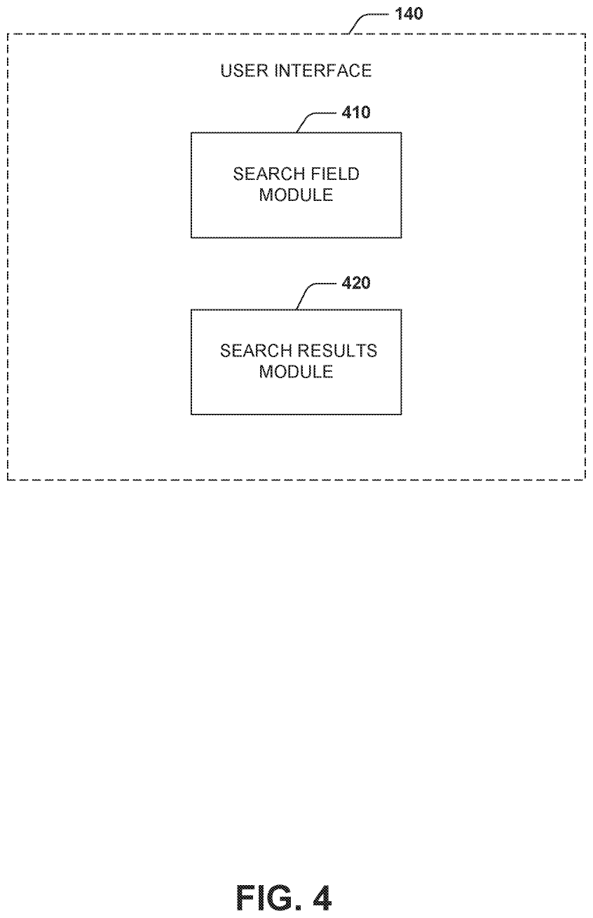

FIG. 4 details the modules that make up the user interface 140. The user interface includes at least a search field module 410 where the user may enter keywords for queries and a search results module 420 that displays query results on the user device 130. The user interface 140 may take the form of a web portal, graphical user interface, command line interface, or other applicable means.

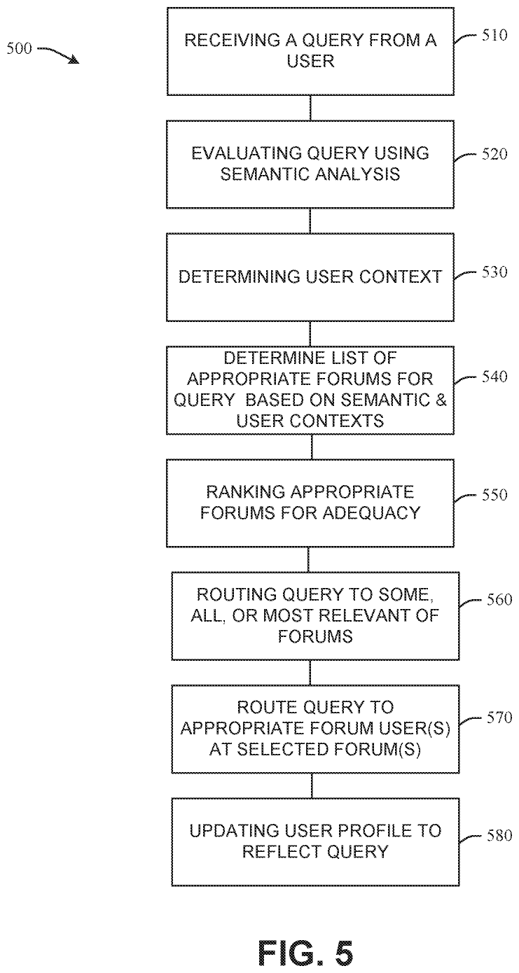

With reference to FIG. 5, example method 500 is depicted for authenticating a user to verify identity. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

FIG. 5 illustrates a method of routing user inquiries to an appropriate forum or forum user. At 510, a query is receives from a user via a user interface. At 520, a semantic context is determined using a semantic analysis, the semantic context including a classification of the query that indicates what the query is asking. At 530, a user context is determined based on an analysis of user data sources. At 540, forums are determined for the query based on the semantic context and the user context. At 550, the appropriate forums are ranked in accordance with an analysis of forum attributes. Forum attributes include at least one of: number of posts, number of interactions, search engine score, and number of competitors. At 560, the query is routed to one or more forums based on the user context and the semantic context.

At 570, a forum user routing is determined. Forum user routing includes determining an appropriate forum user, within the appropriate forum, based on a forum user analysis. The proper forum user is a forum user whose past queries and posts on the forum are sufficiently similar to the present inquiry as to reasonably believe the forum user may offer a helpful response. Forum user analysis can include determining a forum user trust ranking based on forum user attributes. Forum user attributes can include at least one of: previous answers provided to similar inquiries that received high ratings from registered users, user forum ratings, number of likes, claimed expertise, and forum user social media history. After an appropriate forum user is identified, the query is sent directly to the identified forum user based on the forum user analysis.

At 580, user profile information is updated to reflect the query. Additional user information may be updated from third party servers. The user data sources include at least one of: the location of the user, past user queries, user profile data, user social media history, or user behavioral data.

In at least one embodiment the method operates as a push-button application such as a help function. The push-button team member application searches for a relevant team member who can adequately answer a query posed by the user based on the access table information.

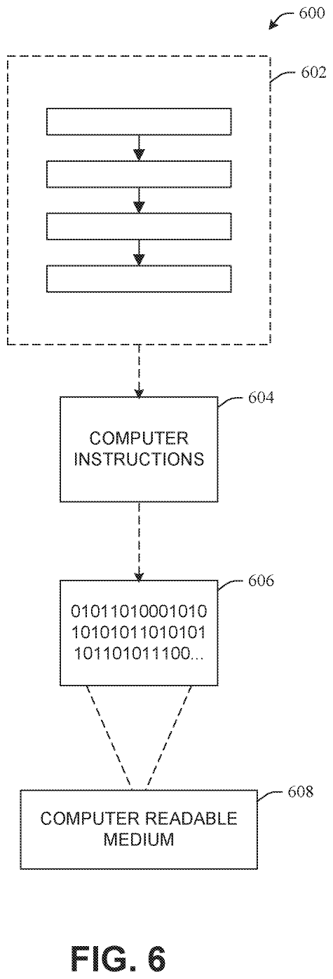

Still another embodiment can involve a computer-readable medium comprising processor-executable instructions configured to implement one or more embodiments of the techniques presented herein. An embodiment of a computer-readable medium or a computer-readable device that is devised in these ways is illustrated in FIG. 6, wherein an implementation 600 comprises a computer-readable medium 608, such as a CD-R, DVD-R, flash drive, a platter of a hard disk drive, etc., on which is encoded computer-readable data 606. This computer-readable data 606, such as binary data comprising a plurality of zero's and one's as shown in 606, in turn comprises a set of computer instructions 604 configured to operate according to one or more of the principles set forth herein. In one such embodiment 600, the processor-executable computer instructions 604 is configured to perform a method 602, such as at least a portion of one or more of the methods described in connection with embodiments disclosed herein. In another embodiment, the processor-executable instructions 604 are configured to implement a system, such as at least a portion of one or more of the systems described in connection with embodiments disclosed herein. Many such computer-readable media can be devised by those of ordinary skill in the art that are configured to operate in accordance with the techniques presented herein.

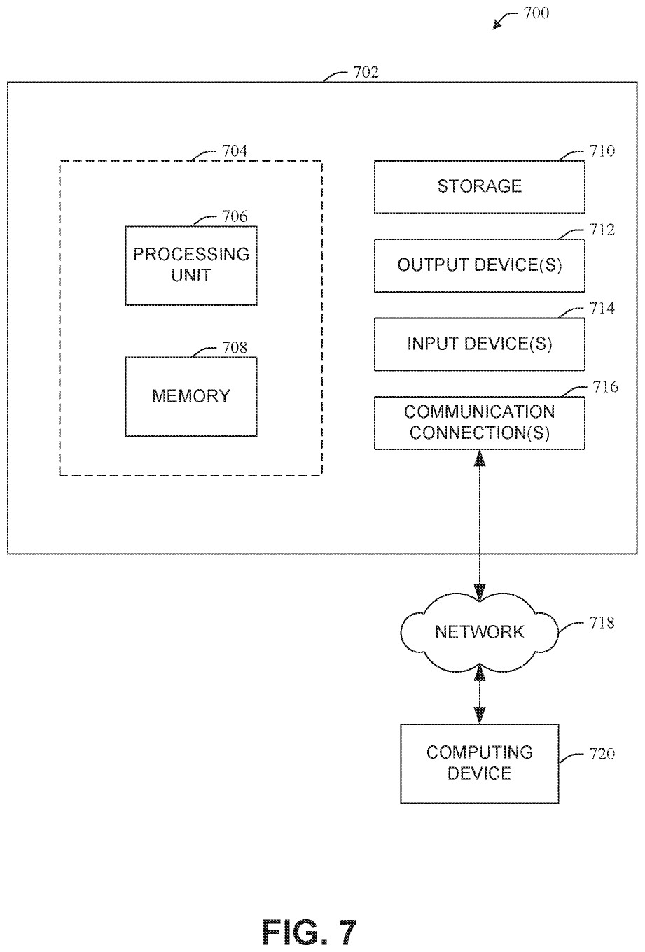

With reference to FIG. 7 and the following discussion provide a description of a suitable computing environment in which embodiments of one or more of the provisions set forth herein can be implemented. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 7 illustrates a system 700 comprising a computing device 702 configured to implement one or more embodiments provided herein. In one configuration, computing device 702 can include at least one processing unit 706 and memory 708. Depending on the exact configuration and type of computing device, memory 708 may be volatile, such as RAM, non-volatile, such as ROM, flash memory, etc., or some combination of the two. This configuration is illustrated in FIG. 7 by dashed line 704.

In these or other embodiments, device 702 can include additional features or functionality. For example, device 702 can also include additional storage such as removable storage or non-removable storage, including, but not limited to, magnetic storage, optical storage, and the like. Such additional storage is illustrated in FIG. 7 by storage 710. In some embodiments, computer readable instructions to implement one or more embodiments provided herein are in storage 710. Storage 710 can also store other computer readable instructions to implement an operating system, an application program, and the like. Computer readable instructions can be accessed in memory 708 for execution by processing unit 706, for example.

The term “computer readable media” as used herein includes computer storage media. Computer storage media includes volatile and nonvolatile, non-transitory, removable and non-removable media implemented in any method or technology for storage of information such as computer readable instructions or other data. Memory 708 and storage 710 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 702. Any such computer storage media can be part of device 702.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 702 can include one or more input devices 714 such as keyboard, mouse, pen, voice input device, touch input device, infrared cameras, video input devices, or any other input device. One or more output devices 712 such as one or more displays, speakers, printers, or any other output device can also be included in device 702. The one or more input devices 714 and/or one or more output devices 712 can be connected to device 702 via a wired connection, wireless connection, or any combination thereof. In some embodiments, one or more input devices or output devices from another computing device can be used as input device(s) 714 or output device(s) 712 for computing device 702. Device 702 can also include one or more communication connections 716 that can facilitate communications with one or more other devices 720 by means of a communications network 718, which can be wired, wireless, or any combination thereof, and can include ad hoc networks, intranets, the Internet, or substantially any other communications network that can allow device 702 to communicate with at least one other computing device 720.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed:

1. A system for location and context-based team member or customer support connect, the system comprising:
a data repository;
a user interface that receives a query from a user; and
a team member customer connect component (TMCCC) comprising:
a data miner that retrieves user data from the data repository and third party servers;
a user context module that determines a user context based on an analysis of user data gathered by the data miner;
a semantic context module that determines a semantic context using a semantic analysis of the query, the semantic context including a classification of the query that indicates what the query is asking; and
a query routing module that routes a query to at least one forum based on the user context and semantic context.

2. The system of claim 1, wherein the data repository includes context data for each registered user stored in at least one of a profile database, a social feed database, a behavioral database, an attribute table, or an access table.

3. The system of claim 1, wherein the TMCCC further comprises:
a forum routing module that routes the query to a forum user at the at least one forum using a forum user analysis, wherein forum user analysis comprises:
comparing the user context and the semantic context with forum user information from a forum database, the forum user information including at least one of past queries or posts by the forum users;
determining a forum user that is most sufficient to answer the query; and
sending the query to the forum user directly.

4. The system of claim 1, wherein the user interface comprises at least:
a search field module where the user may enter keywords for queries; and
a search results module that displays query results on the user device.

5. The system of claim 1, wherein third party servers may provide at least social feed data to the TMCCC for updating at least the profile and social feed data in the data repository.

6. The system of claim 1, wherein the TMCCC comprises:
a registration module that receives attribute information including at least one of name, contact information, or employment information.

7. The system of claim 1, wherein the data miner constructs an attribute table listing user attributes, and constructs an access table based on the attributes using personal and public information of the user.

8. The system of claim 7, wherein the team member application searches for a relevant team member who can adequately answer a query posed by the user based on the access table information.

9. A method, comprising:
receiving a query from a user via a user interface;
determining a user context based on an analysis of user data sources;
determining a semantic context using a semantic analysis, the semantic context including a classification of the query that indicates what the query is asking; and
routing the query to one or more forums based on the user context and the semantic context.

10. The method of claim 9, further comprising:
receiving additional user information from third party servers.

11. The method of claim 9, wherein the user data sources include at least one of:
the location of the user, past user queries, user profile data, user social media history, or user behavioral data.

12. The method of claim 9, further comprising:
determining an appropriate forum routing from a set of forums based on the user context.

13. The method of claim 12, wherein determining the appropriate forum routing includes determining a relevance ranking of the set of forums from an analysis of forum attributes.

14. The method of claim 13, wherein the forum attributes includes at least one of: number of posts, number of interactions, search engine score, or number of competitors.

15. The method of claim 9, further comprising:
determining a forum user routing based on a forum user analysis, and
directly sending a forum user the query based on the forum user analysis.

16. The method of claim 15, the forum user analysis comprising:
determining a forum user trust ranking based on forum user attributes.

17. The method of claim 16, wherein the forum user attributes include at least one of: previous answers provided to similar inquiries that received high ratings from registered users, user forum ratings, number of likes, claimed expertise, or forum user social media history.

18. The method of claim 9, wherein the method operates as a push-button application such as a help function.

19. A non-transitory computer-readable storage medium containing instructions which, when executed, are operative to perform a method, the method comprising:
receiving a query from a user via a user interface;
determining a user context based on an analysis of user data sources;
determining a semantic context using a semantic analysis, the semantic context including a classification of the query that indicates what the query is asking;
and
routing the query to one or more forums based on the user context and the semantic context.

20. The non-transitory computer-readable medium of claim 18, wherein the user data sources include at least one of: the location of the user, past user queries, user profile data, user social media history, or user behavioral data.
